(19) United States
(12) Patent Application Publication
(10) Pub. No.: US 2012/0278009 A1
(43) Pub. Date: Nov. 1, 2012

(54) Melt Pressure Sensor

(75) Inventors: Robert W. Matthes, Loveland, OH (US); David A. Topmiller, Edgewood, KY (US)

(73) Assignee: TRANSDUCERS DIRECT LLC, Cincinnati, OH (US)

(21) Appl. No.: 13/098,409

(22) Filed: Apr. 30, 2011

(51) Int. Cl. G06F 19/00; G01L 7/00

(52) U.S. Cl. 702/52; 702/50; 702/53

(57) ABSTRACT

A melt pressure sensor comprises a housing, a stem, a pressure sensing element, a time-to-digital converter, a processor, a digital-to-analog converter, and a first input. The stem comprises a pressure sensing surface fluidly coupled to a molten material. The pressure sensing surface is mechanically or fluidly coupled to the pressure sensing element, and the pressure sensing element is electrically coupled to the time-to-digital converter, which determines the melt pressure by measuring an electrical characteristic of the pressure sensing element. The processor reads the pressure from the time-to-digital converter and outputs an analog output value from the digital-to-analog converter representative of the melt pressure. When the first input is activated, the processor causes the analog output signal to have a predetermined value.

### TECHNICAL FIELD

The present disclosure generally relates to melt pressure sensors which are capable of measuring the pressure of various types of molten materials.

### BACKGROUND

As background, molding machines, extrusion machines, and other machines having a molten material typically have one or more melt pressure sensors which are capable of measuring the pressure of the molten material. The melt pressure sensor may be used by the control system of the machine as a feedback mechanism to measure and/or control the actual pressure of the molten material. Measuring the actual pressure of the molten material may allow the control system to insure that the product manufactured by the machine maintains a consistent quality.

Many different types of machines may use melt pressure sensors. For example, plastic extrusion machines may employ one or more melt pressure sensors to measure the pressure of the molten plastic extruded by the machine. As another example, a plastic injection molding machine may use one or more melt pressure sensors to measure the pressure of the molten plastic used to make a plastic part. Melt pressure sensors may also be used in other types of machines and may be capable of measuring the pressure of other types of molten materials such as, for example, molten plastic, molten metal, and many other types of molten or liquified materials.

The melt pressure sensors may be capable of measuring the pressure of the molten material which may be generated by the machine and may be part of the process by which a product is made. For example, in a plastic extrusion machine, the molten plastic may be placed under pressure so that the molten plastic is forced through a mold, thereby creating the extruded product. As another example, in a plastic injection molding machine, the molten plastic may be placed under pressure so that the molten plastic is forced into a mold, thereby creating the injected molded part. The molten material may be placed under pressure for other reasons as well. The pressure under which the molten material is placed may vary from zero psi (i.e., pounds per square inch) to 10,000 psi and higher. Other suitable pressure ranges may be used as well. The pressure of the molten material may be measured in pounds per square inch with respect to a perfect vacuum (called psia for “absolute”) or with respect to the ambient atmospheric pressure (called psig for “gauge”). Other units of measuring the melt pressure may be used as well including, but not limited to, bar, Pascals, kiloPascals, and megaPascals.

### SUMMARY

In one embodiment, a melt pressure sensor comprises a housing, a stem, a pressure sensing element, a time-to-digital converter, a processor, a digital-to-analog converter, and a first input. The time-to-digital converter, the processor , the digital-to-analog converter are disposed in the housing, and the pressure sensing element is disposed in the housing or in the stem. The stem comprises a pressure sensing surface fluidly coupled to a molten material, and the housing is mechanically coupled to the stem. The pressure sensing surface is mechanically or fluidly coupled to the pressure sensing element such that at least a portion of the pressure exerted by the molten material on the pressure sensing surface is mechanically or fluidly coupled to the pressure sensing element. The pressure sensing element comprises an electrical characteristic such that a value of the electrical characteristic corresponds to the pressure exerted by the molten material on the pressure sensing surface. The time-to-digital converter is electrically coupled to the pressure sensing element and is operable to measure the value of the electrical characteristic. The processor is electrically coupled to the time-to-digital converter and is operable to read the measured value of the electrical characteristic and to determine the pressure exerted by the molten material on the pressure sensing surface based, at least in part, on the measured value of the electrical characteristic. The processor is electrically coupled to the digital-to-analog converter and is operable to write a digital value to the digital-to-analog converter, wherein the digital value is representative of the pressure. The digital-to-analog converter is operable to convert the digital value to an analog output signal representative of the digital value. And the first input is electrically coupled to the processor such that, when the first input is activated, the processor causes the analog output signal having a predetermined value.

In another embodiment, a method of calibrating a melt pressure sensor is disclosed, wherein the melt pressure sensor comprising a housing, a stem, a pressure sensing element, a time-to-digital converter, a processor, a digital-to-analog converter, and a first input. The time-to-digital converter, the processor , the digital-to-analog converter are disposed in the housing, and the pressure sensing element is disposed in the housing or in the stem. The stem comprises a pressure sensing surface fluidly coupled to a molten material, and the housing is mechanically coupled to the stem. The pressure sensing surface is mechanically or fluidly coupled to the pressure sensing element such that at least a portion of the pressure exerted by the molten material on the pressure sensing surface is mechanically or fluidly coupled to the pressure sensing element. The pressure sensing element comprises an electrical characteristic such that a value of the electrical characteristic corresponds to the pressure exerted by the molten material on the pressure sensing surface. The time-to-digital converter is electrically coupled to the pressure sensing element and is operable to measure the value of the electrical characteristic. The processor is electrically coupled to the time-to-digital converter and is operable to read the measured value of the electrical characteristic and to determine the pressure exerted by the molten material on the pressure sensing surface based, at least in part, on the measured value of the electrical characteristic. The processor is electrically coupled to the digital-to-analog converter and is operable to write a digital value to the digital-to-analog converter, wherein the digital value is representative of the pressure. The digital-to-analog converter is operable to convert the digital value to an analog output signal representative of the digital value. The first input is electrically coupled to the processor; and the method comprises: reading the first input by the processor, and, when the first input is activated, outputting by the processor an analog output having a predetermined value.

### BRIEF DESCRIPTION OF THE DRAWINGS

The embodiments set forth in the drawings are illustrative and exemplary in nature and not intended to limit the inventions defined by the claims. The following detailed description of the illustrative embodiments can be understood when read in conjunction with the following drawings, where like structure is indicated with like reference characters and in which:

FIGS. 1 and 2 show a melt pressure sensor according to one or more embodiments shown and described herein;

FIG. 3 illustrates a pressure sensing element according to one or more embodiments shown and described herein;

FIG. 4 depicts a voltage decay time of an RC circuit according to one or more embodiments shown and described herein;

FIG. 5 shows a schematic diagram of a melt pressure sensor according to one or more embodiments shown and described herein; and

FIG. 6 illustrates an analog output signal according to one or more embodiments shown and described herein.

### DETAILED DESCRIPTION

The embodiments described herein generally relate to apparatuses and methods for measuring the pressure of a molten material. Although many of the embodiments described herein are related to plastic extrusion machines and injection molding machines, it is to be understood that the embodiments shown and described herein are applicable to many types of machines in which the pressure of a molten or liquified material are measured.

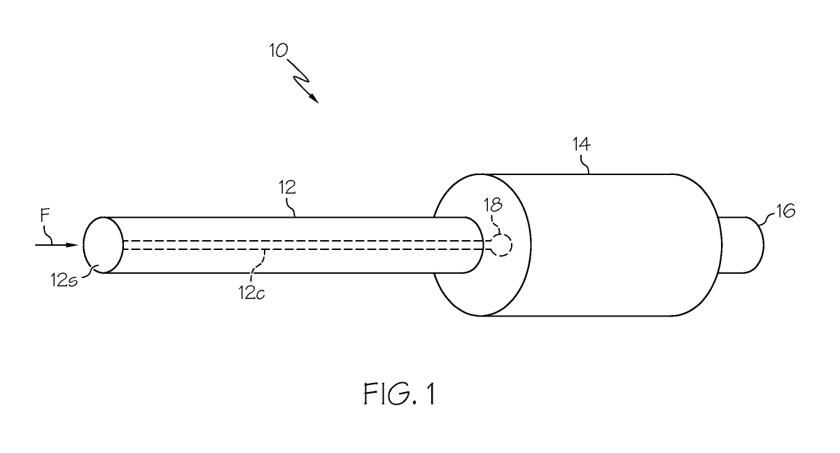

FIG. 1 depicts one embodiment of a melt pressure sensor 10. The sensor may comprise a stem 12, a housing 14, and a connector 16. The stem 12 may be mechanically coupled to the housing 14 and may be cylindrical or any other suitable geometry. The stem 12 may comprise a pressure sensing surface 12s which may be fluidly coupled to the molten material (not shown) such that a force F of the molten material is applied to the pressure sensing surface 12s due to the pressure of the molten material. The pressure sensing surface 12s may be fluidly or mechanically coupled to a pressure sensing element 18 such that at least a portion of the force F applied to the pressure sensing surface 12s is applied to the pressure sensing element 18. This may be performed by a fluid-filled tube 12c (sometimes called a capillary) which may be disposed, at least partially, in the stem 12. The fluid-filled tube 12c may be filled with a fluid such as, but not limited to, mercury and oil, and may transmit at least a portion of the force F of the molten material to the pressure sensing element 18.

Often the molten material not only applies pressure to the pressure sensing surface 12s, but may also move relative to the pressure sensing surface 12s. In some cases, the molten material may move at an angle that is substantially parallel to the pressure sensing surface 12s. The combination of pressure, heat, and motion may cause wear on the pressure sensing surface 12s since the molten material may be viscous and/or may contain solid particles. Thus, the pressure sensing surface 12s may comprise a material capable of withstanding this harsh environment. Such material may include, but are not limited to, stainless steel, titanium, or any other suitable material. The stem 32 may comprise the same or a different material as the pressure sensing surface 12s. In one embodiment, the stem 12 may comprise stainless steel while the pressure sensing surface 12s comprises titanium.

In one embodiment, the pressure sensing element 18 may be disposed in the housing 14, as shown in FIG. 1, such that the pressure sensing element 18 is physically separated from the molten material by at least the length of the stem 12. Such separation may permit the pressure sensing element 18 (and other components disposed in the housing 14) to operate at a cooler temperature than that of the molten material, which may have a temperature of 300 degrees F. or higher. This may permit electronic components, which may be limited to operating at temperatures of 185 degrees F. or lower, to be disposed in the housing 14. In another embodiment, the pressure sensing element may be disposed at the pressure sensing surface 12s in cases, for example, where the temperature of the molten material may be relatively low, or the pressure sensing element 18 is capable of operating at a temperature near or at the temperature of the molten material. In this embodiment, the pressure sensing element 18 may be mechanically coupled directly to the pressure sensing surface 12s, and the remaining electronic components may be disposed in the housing 14. Electrical wires may electrically couple the pressure sensing element 18 to the electronic components disposed in the housing 14.

The pressure of the molten material may cause a force F to be applied to the pressure sensing surface 12s based on the pressure of the molten material and the area of the pressure sensing surface 12s. This pressure and resulting force F may cause the pressure sensing surface 12s to deform to a degree that corresponds to the value of the pressure of the molten material. The deformation of the pressure sensing surface 12s may cause at least a portion of the force F be applied to the fluid in the fluid-filled tube 12c and transferred to the pressure sensing element 18. Thus, the force F created by the pressure of molten material may be opposed in part by the pressure sensing surface 12s and in part by the pressure sensing element 18. For example, approximately 90% of the force F may be opposed by the pressure sensing surface 12s and approximately 10% of the force F may be opposed by the pressure sensing element 18.

The housing 14 may contain electronic and other components of the melt pressure sensor 10 as described herein. For example, a time-to-digital converter, a processor, and a digital-to-analog converter may also be disposed in the housing 14. These components may be mounted on a printed circuit board or other suitable medium. The housing 14 may comprise a metal such as, for example, stainless steel which may protect the contents of the housing 14 from physical damage as well as electromagnetic interference. The housing 14 may also comprise a plastic or composite material which may have a conductive coating for protection against electromagnetic interference.

Referring still to FIG. 1, the housing 14 may comprise a cylindrical shape or any other suitable geometry and may be rigidly coupled to the stem 12. The housing 14 and/or the stem 12 may comprise threads (not shown) which permit the melt pressure sensor 10 to be threaded onto and secured to a mating surface of the machine. In one embodiment, the stem 12 may be inserted into a mating cavity on the machine such that, when the melt pressure sensor 10 is inserted into the cavity, the pressure sensing surface 12s may be capable of contacting the molten material. The melt pressure sensor 10 may further comprise a connector 16 mechanically coupled to the housing 14 which may permit electrical connectivity to the sensor. The connector 16 may comprise two or more conductors which carry the electrical signals to and from the melt pressure sensor 10. The connector 16 may comprise an “M12” connector or a “Bendix” connector, both of which are known in the art. As an alternative to the connector 16, the melt pressure sensor 10 may comprise a cable having two or more conductors. Other types of connectivity may be used as well, as is known in the art, including wireless.

FIG. 2 depicts another embodiment of a melt pressure sensor 30 comprising a stem 32, a housing 34, a pressure sensing element 38, a connector 36, and a flexible conduit 40. The stem 32, housing 34, pressure sensing element 38, and connector 36 may possess the same characteristics and features as the same-named components described in FIG. 1. The stem 32 may comprise stainless steel or other suitable material, as described herein. The stem 32 may comprise a pressure sensing surface 32s, which may comprise titanium, stainless steel, or other suitable material. The stem may further comprise a flange 32f which may facilitate the insertion and securing of the stem 32 in a machine. For example, the flange 32f may include male threads (not shown) which are operable to mate to female threads in a machine such that the stem 32 may be threaded into the machine and tightened.

The housing 34 may comprise stainless steel or other suitable material, as described herein. The housing 34 may contain electronic devices and other components of the melt pressure sensor 30 such as, for example, the time-to-digital converter, the processor, and the digital-to-analog converter. Other components may be disposed in the housing 34 as well. A connector 36 may be mechanically coupled to the housing 34 which may permit electrical connectivity to the melt pressure sensor 30. A cable having a suitable number of conductors may be used in place of the connector 36.

A flexible conduit 40 may mechanically couple the stem 32 to the housing 34. The flexible conduit 40 may comprise a flexible metallic conduit or other suitable material. The flexible conduit 40 may comprise coils of a self-interlocked ribbed strip of aluminum or steel, as is known in the art. This strip may comprise a helical shape so as to permit the flexible conduit 40 to bend at various angles. The flexible conduit 40 may permit the housing 34 to be mounted away from the stem 32, which may be subject to heat from the molten material. The flexible conduit 40 also permits the housing to be mechanically coupled to the machine in a plethora of positions and locations.

A fluid-filled tube 32c may be disposed in the stem 32 and the flexible conduit 40 such that the fluid-filled tube 32c fluidly couples the pressure sensing surface 32s to a pressure sensing element 38 disposed in the housing 34. As discussed herein, at least a portion of the force F applied to the pressure sensing surface 32s may be applied to the pressure sensing element 38. The fluid-filled tube 32c may be filled with a fluid such as, but not limited to, mercury and oil.

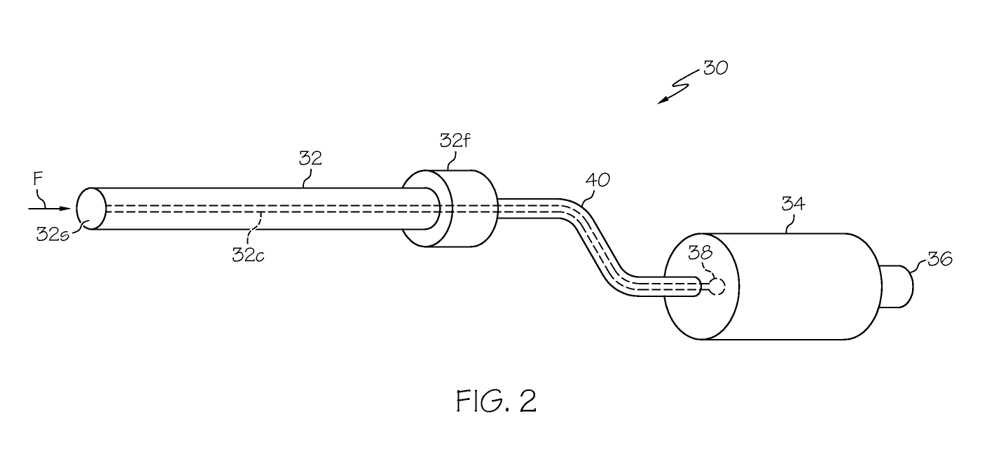

FIG. 3 depicts a pressure sensing element 50 according to one embodiment shown and described herein. The pressure sensing element 50 may comprise a diaphragm 52 and one or more resistors 54, 56. As described herein, at least a portion of the force F′ created by the pressure of the molten material may be fluidly transmitted to the pressure sensing element 50. This force F′ may deform the diaphragm 52, which may comprise steel, aluminum, or other suitable material. The higher the pressure of the molten material, the higher the force F′ on the diaphragm 52, and the more deformed the diaphragm 52 becomes. The resistors 54, 56 may be mechanically coupled to the diaphragm 52 such that the resistors are also deformed by the force F′. The resistors 54, 56 may be designed such that their electrical resistance changes when the resistors 54, 56 are deformed. In one embodiment, a first resistor 56 may be disposed on the diaphragm 52 such that it is elongated when the force F′ on the diaphragm 52 increases, thus increasing the electrical resistance of the first resistor 54. Likewise, a second resistor 56 may be disposed on the diaphragm 52 such that it is shortened when the force F′ on the diaphragm 52 increases, thus decreasing the electrical resistance of the second resistor 56. In this fashion, the pressure of the molten material may be measured by determining the relative change in resistance of the resistors 54, 56 mechanically coupled to the diaphragm 52.

The combination of two resistors 54, 56 is often called a half bridge. Two additional resistors (not shown) may also be disposed on the diaphragm 52 and may operate similar to the resistors 54, 56. That is, the resistance of one of the resistors may increase when the force F′ increases, while the resistance of the other resistor may decrease when the force F′ increases. These four resistors may be used as two independent half bridges such that each half bridge is capable of measuring the force F′ exerted on the diaphragm (and, hence, the pressure of the molten material). As an alternative, the four resistors may be connected as a Wheatstone bridge, which is well-known in the art. It is contemplated that any suitable number of resistors and any suitable arrangement of the resistors may be used in order to effectively measure the force F′ exerted on the diaphragm.

In addition to resistors, one or more capacitors may be used measure the force on the diaphragm 52. In such an embodiment, the electrical capacitance of the one or more capacitors may change as the force F′ on the diaphragm changes. Other types of pressure sensing elements may use a diaphragm and a metal plate such that the electrical capacitance between the diaphragm and the metal place corresponds to the amount of force on the diaphragm. In short, many types of pressure sensing elements may be used.

In one embodiment, the resistors 54, 56 may be mechanically coupled directly to the pressure sensing surface, and the fluid-filled tube may be omitted. In this embodiment, the pressure sensing surface may act as the diaphragm 52 of FIG. 3. The resistors 54, 56 or other sensing components should be capable of withstanding the temperature of the molten material, which are only separated from the molten material by the pressure sensing surface.

The pressure sensing element 50 may comprise an electrical characteristic which corresponds to the pressure of the molten plastic. As discussed herein, the resistors, capacitors, or other components which comprise the pressure sensing element 50 may possess such an electrical characteristic. In one embodiment, the electrical characteristic is the electrical resistance of the one or more resistors which comprise the pressure sensing element 50. In another embodiment, the electrical characteristic is the electrical capacitance of the one or more capacitors which comprise the pressure sensing element 50. Other electrical characteristics may be used as well.

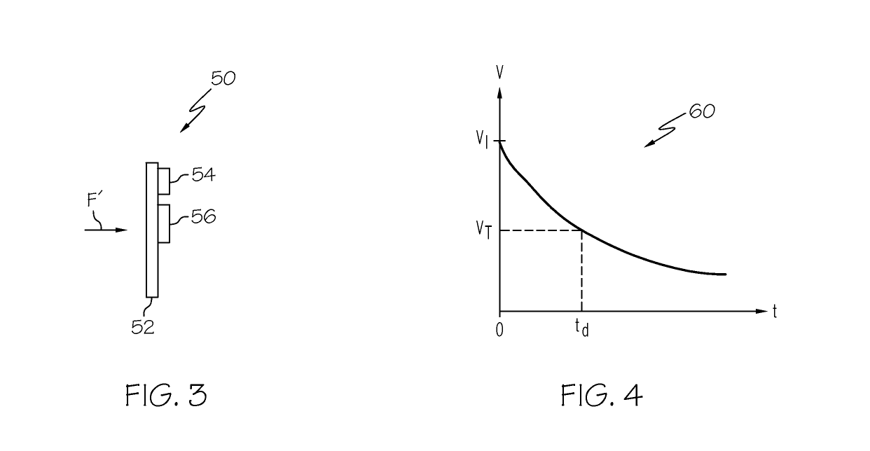

FIG. 4 depicts a voltage decay time of the RC circuit. This phenomenon may be used to measure an electrical characteristic (e.g., electrical resistance or an electrical capacitance) by using a time-to-digital converter. The general concept of a time-to-digital converter is to measure resistance or capacitance indirectly by measuring the voltage decay time of an RC (resistance-capacitance) circuit in which one component (either the R or the C) is relatively constant and the other component possesses the electrical characteristic being measured. For example, if measuring an electrical resistance (R), a fixed capacitor (C) may be used such that the voltage decay time of the RC circuit corresponds to the value of the electrical resistance. Likewise, if measuring an electrical capacitance (C), a fixed resistor (R) may be used such that the voltage decay time of the RC circuit corresponds to the value of the electrical capacitance.

In FIG. 4, the RC circuit may be charged to an initial voltage V_{I}. The RC circuit may be permitted to naturally decay at the well-known rate of e^{-t/RC}, where e is the natural logarithm. Because the decay voltage asymptotically approaches zero, a voltage threshold V_{T} may be selected in order to improve the measurement time. Thus, the voltage decay time t_{d} may be measured from the time of the initial voltage charge V_{I} until the voltage decays to the voltage threshold V_{T}. A counter, time delay circuit, or other suitable means may be used to measure the voltage decay time t_{d}. In one embodiment, a time-to-digital integrated circuit from Acam GmbH, located in Stutensee, Germany (www.acam.de), may be used. For example, the PS021 or PS09 integrated circuits from Acam GmbH may be used as the time-to-digital converter. These integrated circuits are capable is measuring time with a resolution in the tens of picosecond range. Other time-to-digital converters may be used as well, including those from other vendors, those designed with discrete components, and those not yet developed.

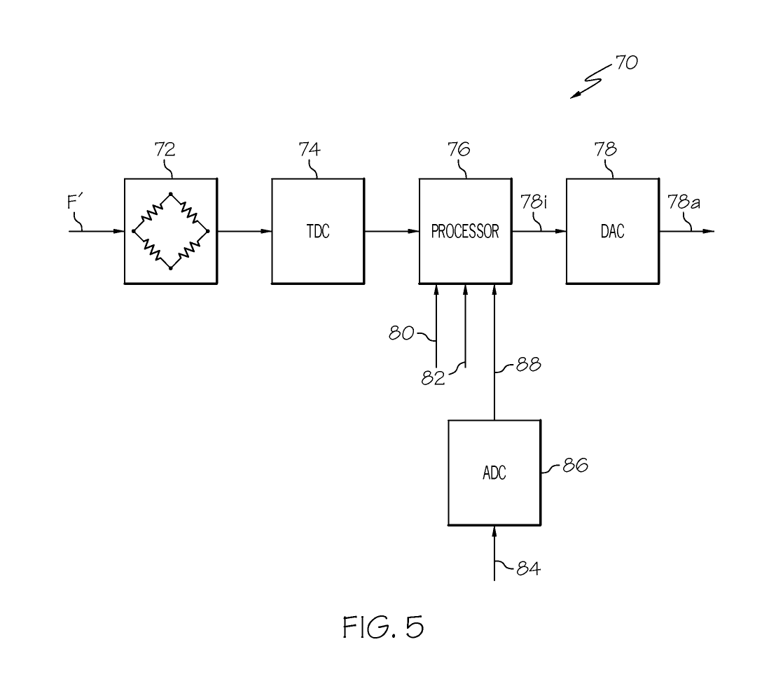

FIG. 5 illustrates a schematic of a melt pressure sensor 70 according to one embodiment shown and described herein. The melt pressure sensor 70 may comprise a pressure sensing element 72, a time-to-digital converter (TDC) 74, a processor 76, a digital-to-analog converter (DAC) 78, and a first input 80. The pressure sensing element 72 may comprise a diaphragm and one or more resistors, as described herein. Alternatively, the pressure sensing element 72 may comprise a diaphragm and one or more capacitors. Other types of pressure sensing elements may be employed as well, as is known in the art. The pressure sensing element 72 may comprise an electrical characteristic, such as electrical resistance or electrical capacitance, the value of which ultimately may correspond to the force exerted by the molten material on the pressure sensing surface. In one embodiment, a pressure sensing element 72 may comprise a Wheatstone bridge comprising four resistors, and the electrical characteristic is the electrical resistance of the bridge resistors or the ratio of the electrical resistance of the bridge resistors. The TDC 74 may be electrically coupled to the pressure sensing element 72 such that the TDC 74 is operable to measure the electrical characteristic which corresponds to the pressure of the molten material. The TDC 74 may comprise a PS021 from Acam GmbH or other suitable integrated circuit. Additionally, the TDC 74 may comprise discrete components such as, for example, counters, timers, voltage comparators, and so forth.

The processor 76 may comprise an 8-bit, 16-bit, 32-bit, or any other suitable processor. In one embodiment, the processor may comprise a PIC24F16KA101 manufactured by Microchip Technology (www.microchip.com), located in Chandler, Ariz. Other types of processors may be used as well, including those from Microchip Technology as well as other suppliers. The processor 76 may be capable of executing computer instructions stored in a program memory (not shown). The methods described herein for operating the melt pressure sensor may be encoded in a computer program comprising such computer instructions. The computer program may be written in any suitable computer language such as, for example, the “C” programming language or assembly language.

Referring still to FIG. 5, the processor 76 may be electrically coupled to the TDC 74 and may be operable to read the measured value of the electrical characteristic and to determine the pressure exerted by the molten material on the pressure sensing surface based, at least in part, on the measured value of the electrical characteristic. The TDC 74 may provide a measured value such as, for example, the ratio of two resistors arranged in a half bridge from the pressure sensing element 72. This measured value of the electrical characteristic may indicate the pressure of the molten material. By way of example and not limitation, if the ratio of two resistors of the pressure sensing element changes by 1.00%, which may indicate an increase in the pressure of the molten material by 1000 psi. A change of 2.00% may indicate an increase in the pressure of the molten material by 2000 psi. Other changes in the electrical characteristic of the pressure sensing element 72 may indicate other changes in pressure of the molten material.

The TDC 74 may be capable of measuring two independent half bridges of the pressure sensing element. The independent measurement may allow the melt pressure sensor to continue to operate, even if one of the half bridges does not operate properly due to, for example, damage from vibration or shock. The TDC 74 may be capable of measuring a Wheatstone bridge or any other suitable resistor arrangement as well.

The digital-to-analog converter (DAC) 78 may convert a digital value 78i from the processor 76 into an analog output signal 78a. The DAC 78 may comprise a converter chip, operational amplifier, and voltage reference. The DAC 78 may convert a digital value 78i to either a voltage or a current which may correspond to the pressure of the molten material. This voltage or current may be transmitted to a control system where it may be measured. In one embodiment, the DAC 78 may convert digital values from the processor 76 to 0 to 10 Volts at the analog output signal 78a. In another embodiment, the DAC 78 may convert digital values from the processor 76 to 4 to 20 milliamps (mA) at the analog output signal 78a. Other analog output signal ranges may be used as well. The DAC 78 may comprise a 16-bit converter chip available from Linear Technology Corp. (www.linear.com) of Milpitas, Calif. In one embodiment, an LTC2601 16-bit converter chip from Linear Technology may be used. The DAC 78 may comprise a voltage reference and/or an operational amplifier as well. The voltage reference may be used to provide a constant voltage to the 16-bit converter chip, while the operational amplifier may be used to amplify the output of the 16-bit converter chip to a suitable voltage level. In one embodiment, an LT1790-2.5 voltage reference may be used and an LT1636 operational amplifier may be used, both available from Linear Technology.

If the analog output signal 78a is a current output (e.g., 4 to 20 mA), the DAC 78 may further comprise a voltage-to-current chip in order to convert the output of the 16-bit converter chip to a current signal of suitable magnitude. In one embodiment, an XTR111 or XTR117 from Texas Instruments (www.ti.com) may be used. Other types of circuits and chips may be used as well, as is known in the art.

The first input 80 may comprise a digital signal which may be electrically coupled to the processor 76 such that, when the first input 80 is activated, the processor 76 causes the analog output signal 78a having a predetermined value. The first input may comprise a 24-Volt input which may be considered activated by the processor 76 when the input is greater than a 12-Volt activation threshold. Other types of inputs may be used as well, including those with a higher or lower voltage rating and/or a higher or lower activation threshold. In addition, the input may be considered “activated” when above or below the activation threshold. Other types of inputs may be used as well, as is known in the art.

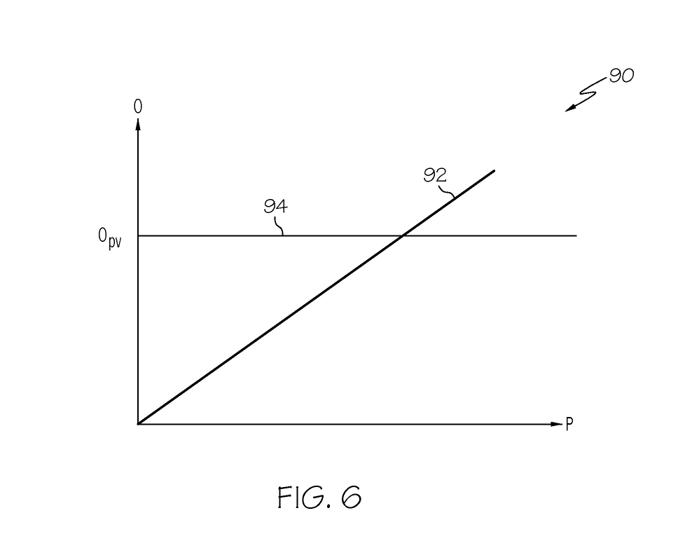

FIG. 6 shows a graph 90 of the analog output signal 0. When the first input is not activated, the analog output signal 0 may linearly increase from zero to a full-scale output. As discussed herein, the full-scale output may be 10 V, 20 mA, or any other suitable value. Thus, as the pressure P (x-axis) of the molten material increases from zero to the rated pressure of the melt pressure sensor, the analog output signal 0 (y-axis) may increase from approximately zero to approximately 10 V. Alternatively, the analog output signal 0 may increase from approximately 4 to approximately 20 mA. It is contemplated that other analog output signal ranges may be used as well. For example, the analog output may range from 0V to 10V, which may represent a pressure of 0 psig (pounds per square inch gauge) to 5000 psig. As another example, the analog output may range from 4 milliamps to 20 milliamps, which may represent a pressure of 0 psig to 5000 psig. Other pressure ranges may be represented as well such as, for example, 0 to 100 psig, 0 to 1000 psig, and 0 to 2500 psig.

When the first input is activated, the processor may cause the analog output signal O to have a predetermined value O_{PV}. This predetermined value O_{PV} may be independent of the actual pressure applied by the molten material on the melt pressure sensor and may be, in one embodiment, approximately 80% of the full-scale output. The type of function is frequently called “Rcal” in the industry. For example, when the first input is activated, the processor may cause the analog output signal to be approximately 8 V (i.e., 80% of a 10 V full-scale output). Alternatively, the processor may cause the analog output signal to be approximately 16 mA (i.e., 80% of a 20 mA full-scale output). Other predetermined values O_{PV} may be used as well including, but not limited to 10%, 50%, 90%, and 100%. Activating the first input (and causing the analog output signal to have a predetermined value O_{PV}) may permit a user of the melt pressure sensor to calibrate the control system to which the melt pressure may be electrically coupled. In this fashion, the user may be able to improve the accuracy of the control system by adjusting the control system to read a known pressure when the first input is activated.

Referring again to FIG. 5, the melt pressure sensor 70 may further comprise a directional input 82 electrically coupled to the processor 76 such that, when the first input 80 is activated, activating the directional input 82 in a first manner causes the processor 76 to increase the predetermined value by a fixed amount, and activating the directional input 82 in a second manner causes the processor to decrease the predetermined value by a fixed amount. The directional input 82 may be a digital input similar to the first input 80, but the directional input 82 may have the capability of being activated in at least two manners. In one embodiment, the directional input 82 may be connected to the power supply voltage of the melt pressure sensor in order to be activated in the first manner, and the directional input 82 may be connected to the power supply ground in order to be activated in a second manner. Other ways of activating the directional input 82 in a first and a second manner may be employed as well, as is known in the art.

When the first input 80 is activated, the processor 76 may increase the predetermined value of the analog output signal 78a by a fixed amount when the directional input 82 is activated in a first manner. In one example, the predetermined value of the analog output signal is 80% of the full-scale output of 10 Volts (i.e., 8 Volts), and the fixed amount is 1 millivolt (mV). Thus, activating the directional input 82 in a first manner causes the processor 76 to increase the predetermined value of 8 Volts by 1 mV, and the analog output signal would be 8.001 V. Every time the directional input 82 is activated, the analog output signal is increased or decreased by 1 mV. Other fixed amounts may be used such as, for example, 10 mV, 20 mV, or 100 mV. If the analog output signal 78a is a current output, the fixed amount may be 1 microamp, 5 microamps, 10 microamps, or any other suitable amount of current. Permitting the user to “adjust” the predetermined value in this fashion may allow the user to fine tune the control system to which the melt pressure sensor 70 may be electrically coupled so that any errors in reading analog output signal 78a from the melt pressure sensor 70 may be minimized or eliminated.

In another embodiment, activating the directional input 82 for at least a predetermined time period may cause the processor 76 to increase or decrease the predetermined value by the fixed amount at an adjustment rate, wherein the adjustment rate increases the longer the directional input is activated. This may operate in a similar manner to a keyboard having a “typematic” feature. As long as the directional input 82 remains activated (either in a first manner or a second manner), the processor 76 may increase or decrease the predetermined value at an adjustment rate, which may initially be one adjustment value (increase or decrease) per second, for example. As the directional input 82 remains activated, the adjustment rate may increase after a 2 or 3 seconds to a rate of one adjustment value per 100 milliseconds. Then, after another 2 or 3 seconds, the adjustment rate may increase to one adjustment value per 10 milliseconds. Such an increase in the adjustment rate over time may allow the user to more quickly adjust the predetermined value. The values given in the example above are only for demonstrative purposes. Other time periods for the directional input 82 to be activated and other adjustment rates may be used as well.

Referring still to FIG. 5, the melt pressure sensor 70 may further comprise an analog-to-digital converter 86. A feedback signal 84 may be electrically coupled to the analog-to-digital converter 86, wherein the feedback signal 84 corresponds to the analog output signal 78a. The analog-to-digital converter 86 may be electrically coupled to the feedback signal 84 and may be capable of converting the feedback signal 84 into a digital feedback signal 88 representative of a voltage or a current of the feedback signal 84. The processor 76 is electrically coupled to the analog-to-digital converter 86 and is operable to read the digital feedback signal 88 from the analog-to-digital converter 86, and when the first input 80 is activated, the processor 76 may adjust the analog output signal 78a such that the feedback signal 84 is substantially equal to the predetermined value. This feature may permit the user to “auto-tune” the melt pressure feedback loop such that the melt pressure sensor itself performs the fine tuning of the feedback loop and reduces or eliminates any errors inherent in the feedback loop.

While particular embodiments and aspects of the present invention have been illustrated and described herein, various other changes and modifications may be made without departing from the spirit and scope of the invention. Moreover, although various inventive aspects have been described herein, such aspects need not be utilized in combination. It is therefore intended that the appended claims cover all such changes and modifications that are within the scope of this invention.

What is claimed is:

1. A melt pressure sensor comprising a housing, a stem, a pressure sensing element, a time-to-digital converter, a processor, a digital-to-analog converter, and a first input, wherein:
the time-to-digital converter, the processor , the digital-to-analog converter are disposed in the housing, and the pressure sensing element is disposed in the housing or in the stem;
the stem comprises a pressure sensing surface fluidly coupled to a molten material;
the housing is mechanically coupled to the stem;
the pressure sensing surface is mechanically or fluidly coupled to the pressure sensing element such that at least a portion of the pressure exerted by the molten material on the pressure sensing surface is mechanically or fluidly coupled to the pressure sensing element;
the pressure sensing element comprises an electrical characteristic such that a value of the electrical characteristic corresponds to the pressure exerted by the molten material on the pressure sensing surface;
the time-to-digital converter is electrically coupled to the pressure sensing element and is operable to measure the value of the electrical characteristic;
the processor is electrically coupled to the time-to-digital converter and is operable to read the measured value of the electrical characteristic and to determine the pressure exerted by the molten material on the pressure sensing surface based, at least in part, on the measured value of the electrical characteristic;
the processor is electrically coupled to the digital-to-analog converter and is operable to write a digital value to the digital-to-analog converter, wherein the digital value is representative of the pressure;
the digital-to-analog converter is operable to convert the digital value to an analog output signal representative of the digital value; and
the first input is electrically coupled to the processor such that, when the first input is activated, the processor causes the analog output signal having a predetermined value.

2. The melt pressure sensor of claim 1, wherein the predetermined value of the analog output signal is approximately 80% of a full-scale output of the analog output signal.

3. The melt pressure sensor of claim 2, wherein the full-scale output of the analog output signal is approximately 10 Volts or approximately 20 milliamps.

4. The melt pressure sensor of claim 1 further comprising a second input electrically coupled to the processor, wherein a value of the second input determines the predetermined value of the analog output signal.

5. The melt pressure sensor of claim 4, wherein the value of the second input is adjustable by a user of the melt pressure sensor.

6. The melt pressure sensor of claim 5, wherein the second input comprises one or more digital switches capable of being set by the user.

7. The melt pressure sensor of claim 1, wherein the pressure sensing element comprises one or more resistors, and the electrical characteristic is an electrical resistance of the one or more resistors.

8. The melt pressure sensor of claim 7, wherein the pressure sensing element comprises four resistors arranged as a Wheatstone Bridge.

9. The melt pressure sensor of claim 7, wherein the pressure sensing element comprises two resistors arranged as a half bridge.

10. The melt pressure sensor of claim 1, wherein the pressure sensing element comprises one or more capacitors, and the electrical characteristic is an electrical capacitance of the one or more capacitors.

11. The melt pressure sensor of claim 1, wherein the time-to-digital converter measures the electrical characteristic of the pressure sensing element by measuring a voltage decay time through the pressure sensing element.

12. The melt pressure sensor of claim 1, further comprising a directional input electrically coupled to the processor such that, when the first input is activated, activating the directional input in a first manner causes the processor to increase the predetermined value by a fixed amount, and activating the directional input in a second manner causes the processor to decrease the predetermined value by a fixed amount.

13. The melt pressure sensor of claim 12, wherein the fixed amount is between approximately 100 microvolts and approximately 10 millivolts or between approximately 1 microamp and approximately 100 microamps.

14. The melt pressure sensor of claim 12, wherein activating the directional input for at least a predetermined time period causes the processor to increase or decrease the predetermined value by the fixed amount at an adjustment rate, wherein the adjustment rate increases the longer the directional input is activated.

15. The melt pressure sensor of claim 1, further comprising an analog-to-digital converter, wherein:
a feedback signal is electrically coupled to the analog-to-digital converter, wherein the feedback signal corresponds to the analog output signal;
the analog-to-digital converter is electrically coupled to the feedback signal and is capable of converting the feedback signal into a digital feedback signal representative of a voltage or a current of the feedback signal;
the processor is electrically coupled to the analog-to-digital converter and is operable to read the digital feedback signal from the analog-to-digital converter; and
when the first input is activated, the processor adjusts the analog output signal such that the feedback signal is substantially equal to the predetermined value.

16. The melt pressure sensor of claim 1, wherein the pressure sensing element comprises two half bridges capable of operating independently of each other such that, if one half bridge fails, the other half bridge is capable of measuring the pressure of the molten material.

17. A method of calibrating a melt pressure sensor, the melt pressure sensor comprising a housing, a stem, a pressure sensing element, a time-to-digital converter, a processor, a digital-to-analog converter, and a first input, wherein:
the time-to-digital converter, the processor , the digital-to-analog converter are disposed in the housing, and the pressure sensing element is disposed in the housing or in the stem;
the stem comprises a pressure sensing surface fluidly coupled to a molten material;
the housing is mechanically coupled to the stem;
the pressure sensing surface is mechanically or fluidly coupled to the pressure sensing element such that at least a portion of the pressure exerted by the molten material on the pressure sensing surface is mechanically or fluidly coupled to the pressure sensing element;
the pressure sensing element comprises an electrical characteristic such that a value of the electrical characteristic corresponds to the pressure exerted by the molten material on the pressure sensing surface;
the time-to-digital converter is electrically coupled to the pressure sensing element and is operable to measure the value of the electrical characteristic;
the processor is electrically coupled to the time-to-digital converter and is operable to read the measured value of the electrical characteristic and to determine the pressure exerted by the molten material on the pressure sensing surface based, at least in part, on the measured value of the electrical characteristic;
the processor is electrically coupled to the digital-to-analog converter and is operable to write a digital value to the digital-to-analog converter, wherein the digital value is representative of the pressure;
the digital-to-analog converter is operable to convert the digital value to an analog output signal representative of the digital value;
the first input is electrically coupled to the processor; and the method comprises:
reading the first input by the processor; and
when the first input is activated, outputting by the processor an analog output having a predetermined value.

18. The method of claim 17, wherein the predetermined value is approximately 80% of a full-scale output of the analog output signal.

19. The method of claim 18, wherein the full-scale output of the analog output signal is approximately 10 Volts or approximately 20 milliamps.

20. The method of claim 17, wherein the melt pressure sensor further comprises a directional input electrically coupled to the processor, and the method further comprises:
reading the directional input by the processor,
when the first input is activated and the directional input is activated in a first manner, increasing the analog signal by a fixed amount; and,
when the first input is activated and the the directional input is activated in a second manner, decreasing the analog signal by a fixed amount.

21. The method of claim 17, wherein the melt pressure sensor further comprises an analog-to-digital converter electrically coupled to the processor, wherein the the analog-to-digital converter is electrically coupled to a feedback signal and is capable of converting the a voltage or a current of the feedback signal into a digital feedback signal representative of the voltage or current of the feedback signal;
the processor is electrically coupled to the analog-to-digital converter and is operable to read the digital feedback signal from the analog-to-digital converter; and the method further comprises:
adjusting the analog output signal by the processor such that feedback signal is substantially equal to the predetermined value.
